(19) United States
(12) Patent Application Publication
(10) Pub. No.: US 2003/0107601 A1
(43) Pub. Date: Jun. 12, 2003

(54) Mechanism for displaying an image that represents the dragging object during a drag and drop operation in JAVA application

(76) Inventor: Aleksandr O. Ryzhov, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/006,719

(22) Filed: Dec. 10, 2001

(51) Int. Cl. G09G 5/00

(52) U.S. Cl. 345/769

(57) ABSTRACT

A method and associating apparatus for displaying an image that represents a dragging object allow Java applications to implement better visual effects during a drag and drop operation. The method and apparatus is an extension to a standard Java drag and drop API that supports drag image. Without limiting the size of the drag image, the method and apparatus allow the drag image to appear semi-transparent, achieving a better visual effect. Displaying an image of a dragging object typically gives the user additional information about the dragging object, thus making the dragging operation more intuitive.

### TECHNICAL FIELD

The technical field relates to JAVA® applications, and, in particular, to mechanism for displaying an image that represents the dragging object during a drag and drop operation in JAVA® applications. (JAVA is a trademark of Sun Microsystems, Inc.)

### BACKGROUND

Drag and drop is an important feature in modem graphical user interfaces (GUI). In general, drag and drop is a process of selecting a source and a destination object, and performing a certain function (operation) that involves data transfer from the source to the destination object. Visual effects during drag and drop operation are intended to make an impression that the source object is being “dragged” across the screen to the destination object. These visual effects can include a specific mouse cursor and/or an image located under the mouse cursor. For example, standard drag and drop in windows operates as follows: select a file to be copied by a mouse, and press the mouse button; open another window of the folder where the file is to be copied; and press the mouse button to start moving the mouse button towards another window. An image of the file is displayed under the mouse cursor. For example, the image may include the folder with a name and some icon representing the file.

Drag and drop application programming interface (API) in Java applications covers basic drag and drop functionality. The visual effects supported by the API include different mouse cursors and include the ability to specify an image to be displayed during dragging, referred to as a drag image. However, drag image support is not implemented in more recent versions of SUN JRE®. In other words, standard Java libraries don't support displaying an image of the object during dragging. (SUN JRE is a registered trademark of Sun Microsystems, Inc.)

Since the support of drag image is important for GUI, some applications implement the drag image feature without using the standard drag and drop API. However, these solutions typically only allow drag and drop within one visual component or within one window.

### SUMMARY

A method for displaying an image of a dragging object during a drag and drop operation includes installing one or more keyboard and mouse event listeners to a Java application implemented in a window, and attaching a custom glass pane to the window where the mouse cursor is located. The one or more keyboard and mouse event listeners follows movements of a mouse cursor. The method further includes displaying a drag image approximate the mouse cursor using the custom glass pane. The drag image represents the dragging object and moves with the mouse cursor.

An embodiment of the method includes removing the custom glass pane from the window after the drag and drop operation.

Another embodiment of the method includes repainting the drag image using the custom glass pane.

Yet another embodiment of the method includes detaching the custom glass pane from a previous window, and attaching the custom glass pane to a next window where the mouse cursor is currently located.

The method and associating apparatus for displaying an image that represents a dragging object allow Java applications to implement better visual effects during a drag and drop operation. Displaying an image of a dragging object typically gives the user additional information about the dragging object, thus making the dragging operation more intuitive.

### DESCRIPTION OF THE DRAWINGS

The preferred embodiments of a method and apparatus for displaying an image of a dragging object during a drag and drop operation will be described in detail with reference to the following figures, in which like numerals refer to like elements, and wherein:

FIG. 1 illustrates an exemplary method and apparatus for displaying a drag image on a glass pane contained in a swing window;

FIGS. 2A and 2B show visual appearance of a semi-transparent drag image under a mouse cursor during a drag and drop operation;

FIG. 3 is a flow chart illustrating the operation of the exemplary method for displaying an image of a dragging object during a drag and drop operation;

FIG. 4 illustrates an exemplary main menu of a ServiceGuard Manager (SGMGR) application;

FIG. 5 illustrates an exemplary process of a default implementation of the exemplary method for displaying an image of a dragging object during a drag and drop operation in the SGMGR application;

FIG. 6 illustrates an exemplary process of a custom implementation of the exemplary method for displaying an image of a dragging object during a drag and drop operation in the SGMGR application; and

FIG. 7 illustrates exemplary hardware components of a computer that may be used in connection with the method for displaying an image of a dragging object during a drag and drop operation.

### DETAILED DESCRIPTION

A method and associating apparatus for displaying an image that represents a dragging object allow Java applications to implement better visual effects during a drag and drop operation. The method and apparatus is an extension to a standard Java drag and drop API that supports drag image, by replacing some of standard API classes. The standard drag and drop API operates with drag sources and drop targets. A drag source is a visual component that can be dragged, whereas a drop target is a visual component that can accept a drop of certain kinds of data. The standard drag and drop API allows making visual components drag sources and drop targets, by sending an event when a drag gesture is performed by a user. A drag gesture is an input event signaling that the user is beginning a dragging operation. The standard drag and drop API allows the applications to catch different kinds of events during the dragging operation. Programmers may use the events to customize the behavior of the dragging operation according to the programmers' needs. Without limiting the size of the drag image, the method and apparatus allow the drag image to appear semi-transparent, achieving a better visual effect than the standard drag and drop API. Displaying an image of a dragging object typically gives the user additional information about the dragging object, thus making the dragging operation more intuitive.

The method and apparatus for displaying the drag image utilize different Java library functions. For example, the method and apparatus for displaying the drag image uses capabilities of a Java foundation classes (JFC) library, referred to as Swing, in conjunction with the standard drag and drop API.

The method and apparatus for displaying the drag image include two separate mechanisms, i.e., subsystem 1 that displays the drag image in a window using the JFC swing, and subsystem 2 that extends the standard drag and drop API implementation that controls subsystem 1. In order to keep track of mouse movement during dragging, the method and apparatus for displaying the drag image install a custom glass pane on top of a window. A glass pane is a component that is displayed on top of other components. By default, the glass pane of the window is completely transparent. The custom glass pane installed by the method and apparatus typically displays a ghost image of a dragging object under a mouse cursor. When the mouse cursor moves on top of a different window, the method and apparatus for displaying the drag image remove the custom glass pane from the previous window and install the glass pane object to the next window, on top of which the mouse cursor is located. When the dragging operation ends, the method and apparatus remove the glass pane object from the window, making the drag image disappear.

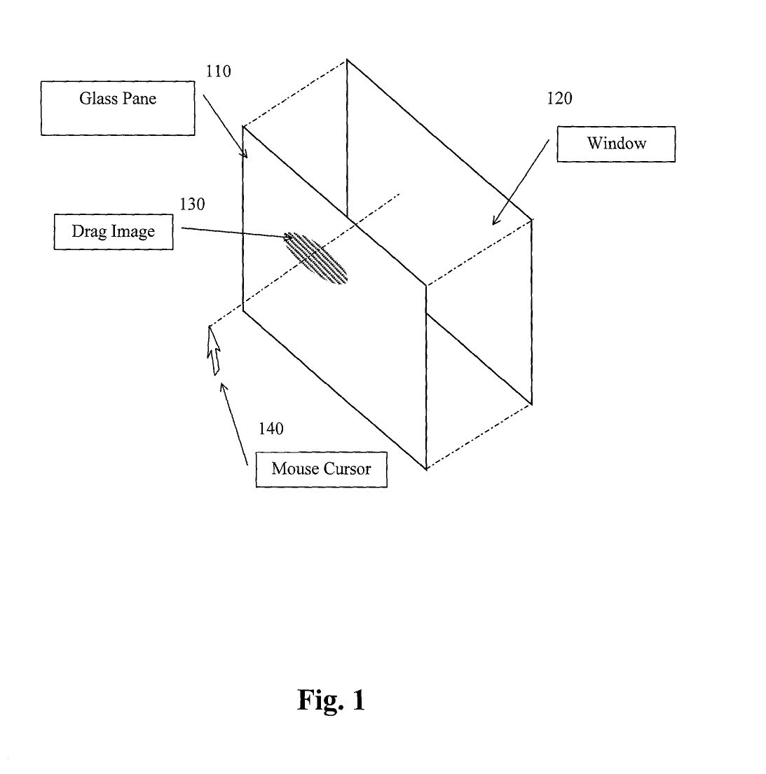

FIG. 1 illustrates an exemplary subsystem 1 for displaying a drag image 130 on a glass pane 110 contained in a swing window 120. As defined earlier, the glass pane 110 is a visual component displayed on top of the window 120, and is completely transparent by default. The swing window 120 may implement an interface to replace the transparent default glass pane 110 with a custom glass pane 110. The custom glass pane 110 is able to display a given drag image 130 at given coordinates. The custom glass pane 110 may be implemented by a skillful Java programmer. The displayed image may be made half-transparent using alpha channel, for example, by changing alpha channel value for each pixel of an original image. In Java graphics API, alpha channel is a component of a pixel data that controls the pixel's transparency. If the glass pane 110 contains half-transparent pixels, the glass pane 110 may enable window contents to be visible through the drag image 130.

Subsystem 2 provides an extension of the standard drag and drop API implementation, which controls subsystem 1. As described above, the standard implementation does not support drag images 130 in versions of Java runtime environment (JRE), which includes java interpreter and standard JFC libraries. In Java drag and drop API, the drag and drop implementation is specified at the beginning of each drag and drop operation.

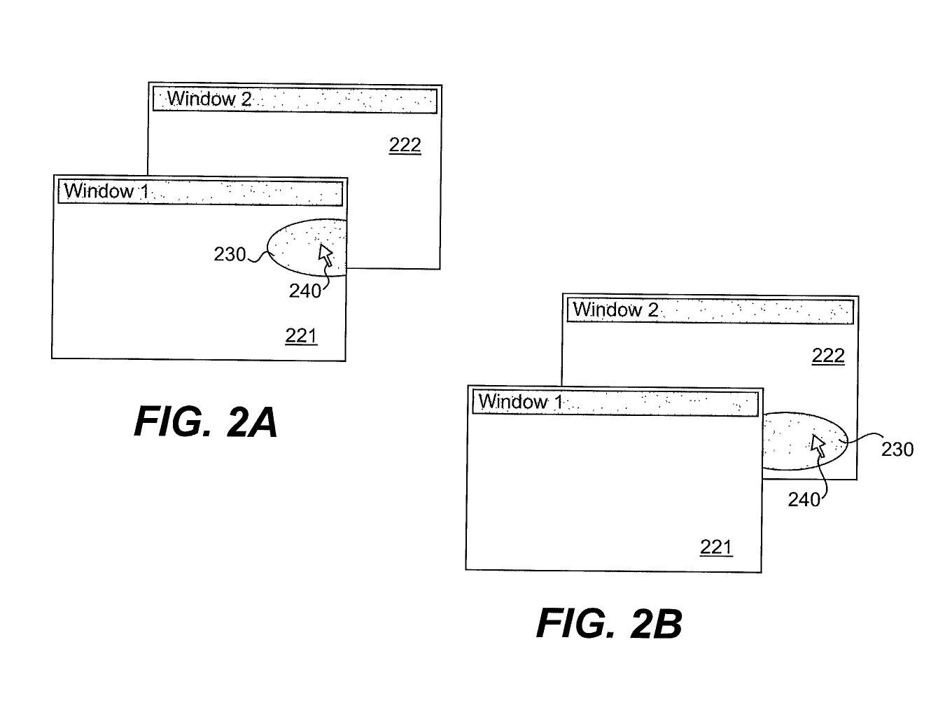

FIGS. 2A and 2B show visual appearance of a semi-transparent drag image 230 under a mouse cursor 240 during a drag and drop operation. Referring to FIG. 2A, the drag image 230 is painted only in one window 221 at a time. When the mouse cursor 240 is located in an area not covered by the windows of an application, the drag image 230 is not shown. Accordingly, when a mouse cursor 240 moves from one window 221 to another window 222, shown in FIGS. 2A and 2B, the drag image 230 may be partially cut off if the mouse cursor 240 is located close to the border of the window 221.

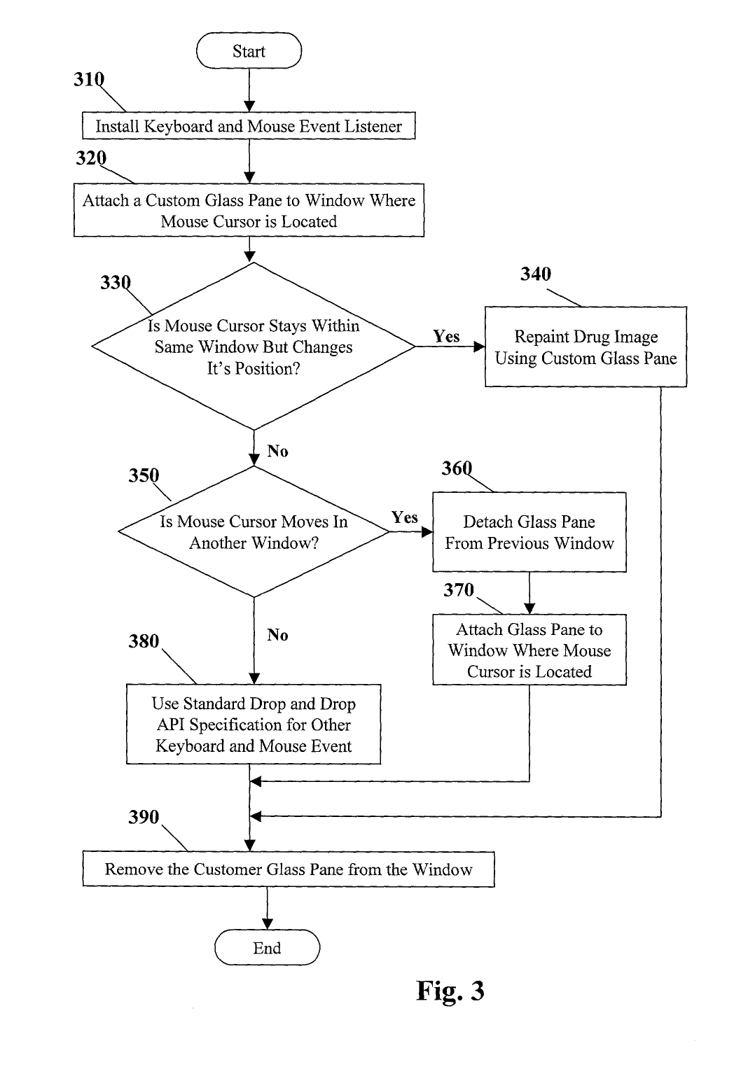

FIG. 3 is a flow chart illustrating the operation of an exemplary method for displaying an image of a dragging object during a drag and drop operation. First, subsystem 2 installs one or more keyboard and mouse event listeners for following movements of the mouse cursor 140 (block 310). The one or more keyboard and mouse event listeners are typically at global application level, so that the listener catches all keyboard and mouse events in the application. Next, subsystem 2 attaches the custom glass pane 110 to the window 120 where the mouse cursor 140 is located (block 320). Then, for each keyboard or mouse event, if the mouse cursor 140 stays within the same window but changes position (block 330), subsystem 2 repaints the drag image 130 using the custom glass pane 110 attached to the current window 120 (block 340). If the mouse cursor 140 moves into another window 120 (block 350), subsystem 2 detaches the custom glass pane 110 from the previous window 120 (block 360) and attaches the custom glass pane 110 to the window 120 where the mouse cursor 140 is located (block 370). Subsystem 2 then manages other keyboard and mouse events according to the standard drag and drop API specification (block 380). After each dragging operation, subsystem 2 removes the custom glass pane 110 from the window 120, so that the drag image 130 disappears.

Before attaching the custom glass pane 110 to the window 120, subsystem 2 typically saves currently installed glass pane 110 in a storage device. After detaching the custom glass pane 110 from the window 120 at the end of a drag operation, subsystem 2 typically attaches previously saved glass pane 110 to the window 120. Saving and restoring existing glass pane 110 is important for some applications that use the glass pane 110 of the window 120 for other purposes.

The method and apparatus for displaying an image of a dragging object during a drag and drop operation is implemented in an application, such as ServiceGuard Manager (SGMGR) application, available from Hewlett Packard Co. The SGMGR is a visual tool to manage entities, such as ServiceGuard, ServiceGuard oracle parallel server (OPS) edition, metro cluster, continental clusters, and to maintain high availability (HA). Using the SGMGR, operators see color-coded, graphically intuitive icons to get the big-picture view of multiple clusters so that they can proactively manage the clusters, systems (or nodes), and applications. The SGMGR enables operators to quickly identify problems and dependencies with drill-down screens for more than one HA cluster, and enables operators to quickly know service guard status, thus minimizing operator training requirements. System administrators can validate the current service guard cluster, node, and package configuration through visualization. The following describes a drag and drop operation in connection with the SGMGR. However, one skilled in the art will appreciate that the drag and drop operation can be equally applied to other applications or entities having the same or similar functions.

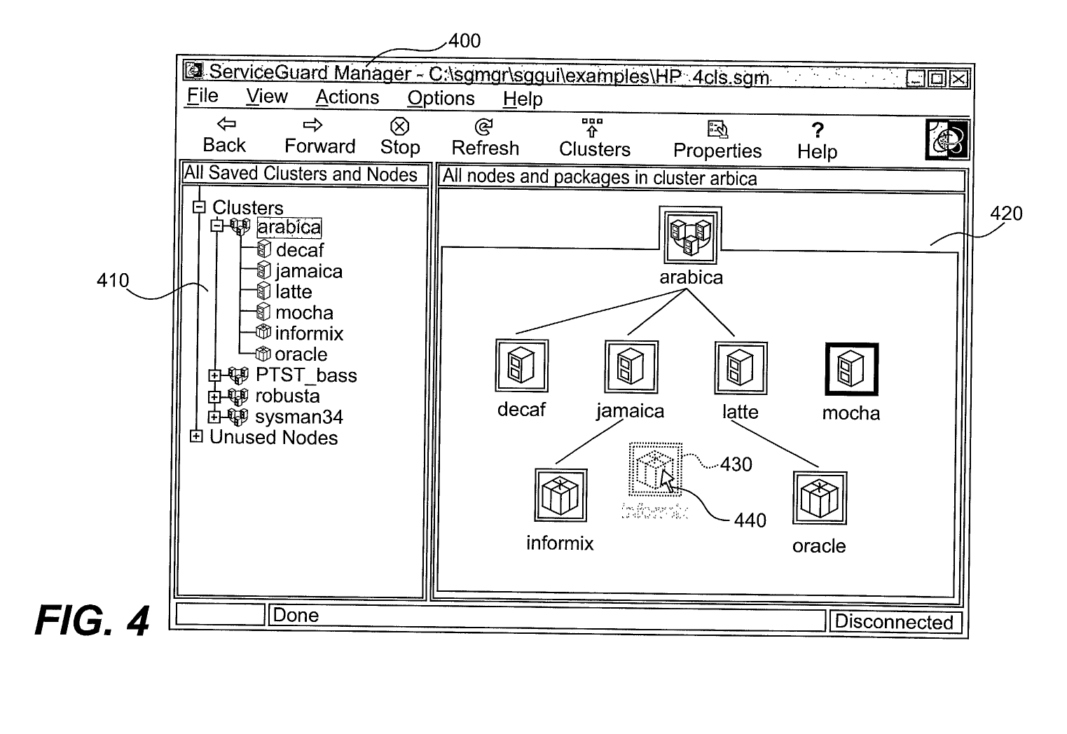

FIG. 4 illustrates an exemplary main menu of an SGMGR application, which contains two major areas: a tree panel 410 and a map panel 420. The SGMGR supports drag and drop of the elements of the tree panel 410 and the map panel 420. During a drag and drop operation, the SGMGR displays a half-transparent image 430 of the element (Informix) that is being dragged using a mouse cursor 440.

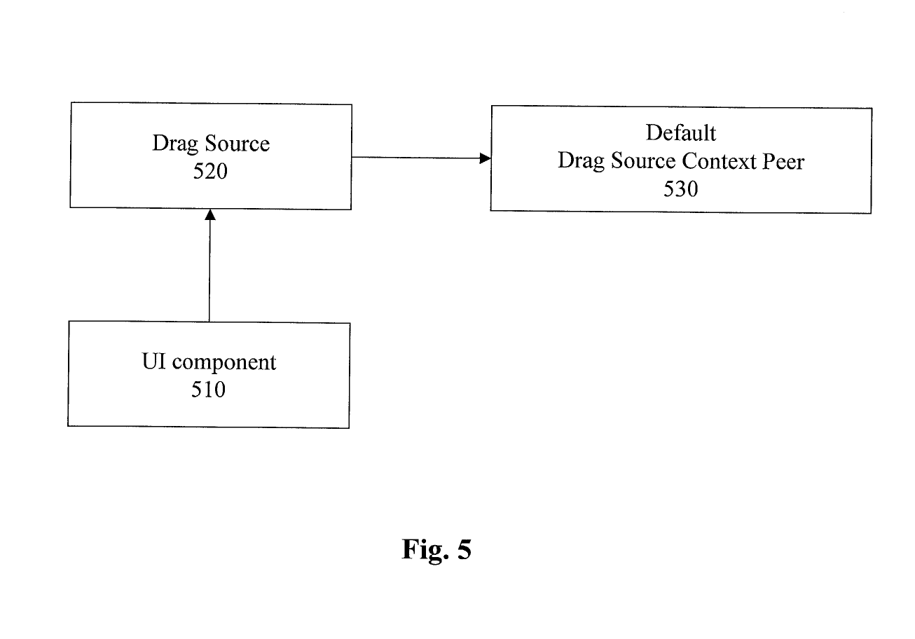

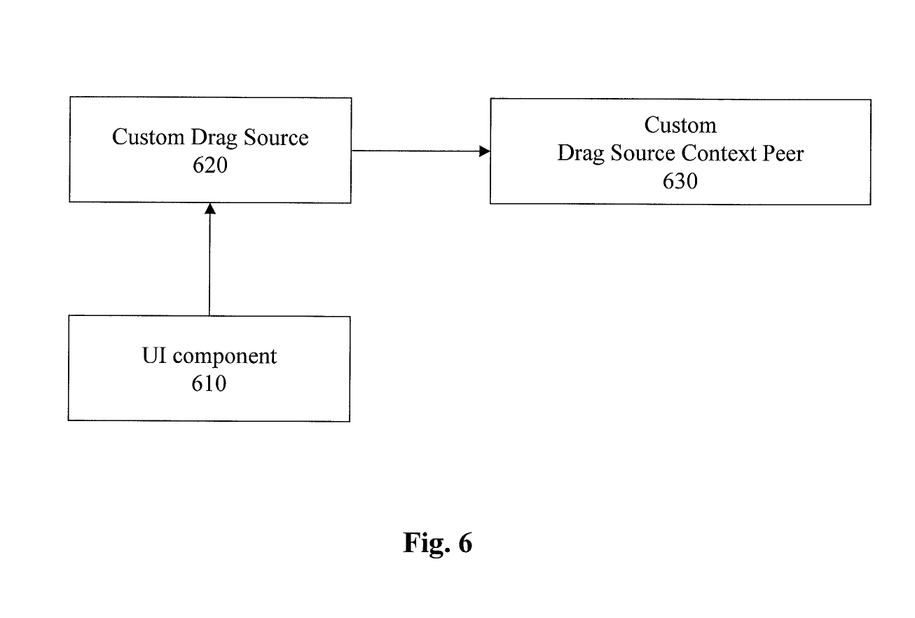

In the SGMGR, subsystem 2 is integrated with the standard drag and drop API through an interface, such as DragSourceContextPeer. The DragSourceContextPeer provides the drag and drop implementation. FIG. 5 illustrates an exemplary process of a default, i.e., standard, implementation of the interface, whereas FIG. 6 illustrates an exemplary process of a custom implementation of the interface.

Referring to FIG. 5, the default implementation of the interface is provided, for example, in SUN JRE®. The SGMGR initiates a drag and drop operation by attaching class DragSource 520 to all draggable GUI components 510 in the tree 410 and the map 420. Then, class DragSource 520 is implemented using an interface Default DragSourceContextPeer 530. (SUN JRE is a registered trademark of Sun Microsystems, Inc.)

Referring to FIG. 6, the SGMGR extends class DragSource 520 (shown in FIG. 5) to class CustomDragSource 620, which replaces the interface Default DragSourceContextPeer 530 with an interface Custom DragSourceContextPeer 630. Similarly, the SGMGR initiates a drag and drop operation by attaching class CustomDragSource 620 to all draggable GUI components 510 in the tree 410 and the map 420. CustomDragSource 620 uses custom drag and drop implementation, i.e., Custom DragSourceContextPeer 630, as opposed to default drag and drop implementation. Since drag and drop implementation involves data transfer, the custom implementation of subsystem 2 is typically limited to using drag and drop within one instance of Java virtual machine (JVM), i.e., both source and target objects may be located in the same instance of JVM. The default drag and drop implementation is not limited to one JVM instance because the implementation uses platform-specific libraries.

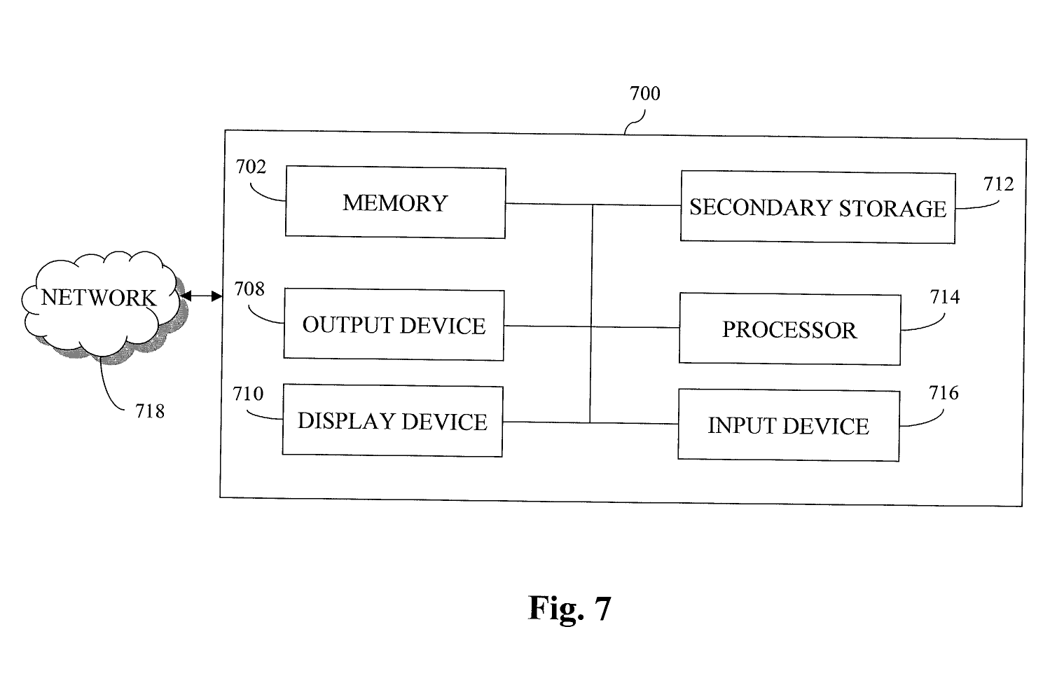

FIG. 7 illustrates exemplary hardware components of a computer 700 that may be used in connection with the method for displaying an image of a dragging object during a drag and drop operation. The computer 700 includes a connection with a network 718 such as the Internet or other type of computer or telephone networks. The computer 700 typically includes a memory 702, a secondary storage device 712, a processor 714, an input device 716, a display device 710, and an output device 708.

The memory 702 may include random access memory (RAM) or similar types of memory. The secondary storage device 712 may include a hard disk drive, floppy disk drive, CD-ROM drive, or other types of non-volatile data storage, and may correspond with various databases or other resources. The processor 714 may execute information stored in the memory 702, the secondary storage 712, or received from the Internet or other network 718. The input device 716 may include any device for entering data into the computer 700, such as a keyboard, keypad, cursor-control device, touch-screen (possibly with a stylus), or microphone. The display device 710 may include any type of device for presenting visual image, such as, for example, a computer monitor, flat-screen display, or display panel. The output device 708 may include any type of device for presenting data in hard copy format, such as a printer, and other types of output devices including speakers or any device for providing data in audio form. The computer 700 can possibly include multiple input devices, output devices, and display devices.

Although the computer 700 is depicted with various components, one skilled in the art will appreciate that the computer 700 can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 700 to perform a particular method.

While the method and apparatus for displaying an image of a dragging object during a drag and drop operation have been described in connection with an exemplary embodiment, those skilled in the art will understand that many modifications in light of these teachings are possible, and this application is intended to cover any variations thereof.

What is claimed is:

1. A method for displaying an image of a dragging object during a drag and drop operation, comprising:
installing one or more keyboard and mouse event listeners to a Java application implemented in a window, wherein the one or more keyboard and mouse event listeners follows movements of a mouse cursor;
attaching a custom glass pane to the window, wherein the mouse cursor is located in the window; and
displaying a drag image approximate the mouse cursor using the custom glass pane, wherein the drag image represents the dragging object and moves with the mouse cursor.

2. The method of claim 1, further comprising removing the custom glass pane from the window after the drag and drop operation.

3. The method of claim 1, wherein the displaying step includes repainting the drag image using the custom glass pane.

4. The method of claim 1, wherein the displaying step comprises:
detaching the custom glass pane from a previous window; and
attaching the custom glass pane to a next window where the mouse cursor is currently located.

5. The method of claim 1, wherein the displaying step includes using a standard drag and drop application programming interface (API) specification.

6. The method of claim 1, wherein the installing step includes installing the one or more keyboard and mouse event listeners at a global application level.

7. The method of claim 1, further comprising saving a currently installed glass pane in a storage device before attaching the custom glass pane to the window.

8. The method of claim 1, further comprising reattaching a previously saved glass pane to the window after removing the custom glass pane from the window after the drag and drop operation.

9. An apparatus for displaying an image of a dragging object during a drag and drop operation, comprising:
a window for implementing a Java application;
one or more keyboard and mouse event listeners for following movements of a mouse cursor; and
a custom glass pane attached to the window, wherein the custom glass pane displays a drag image approximate the mouse cursor, and wherein the drag image represents the dragging object and moves with the mouse cursor.

10. The apparatus of claim 9, wherein the custom glass pane is removed from the window after the drag and drop operation.

11. The apparatus of claim 9, wherein the drag image is repainted to the window by the custom glass pane.

12. The apparatus of claim 9, wherein the custom glass pane is detached form a previous window and attached to a next window where the mouse cursor is currently located.

13. The apparatus of claim 9, wherein a currently installed glass pane is saved in a storage device before the custom glass pane is attached to the window.

14. The apparatus of claim 9, wherein a previously saved glass pane is reattached to the window after the custom glass pane is removed from the window after the drag and drop operation.

15. A computer readable medium providing instructions for displaying an image of a dragging object during a drag and drop operation, the instructions comprising:
installing one or more keyboard and mouse event listeners to a Java application implemented in a window, wherein the one or more keyboard and mouse event listeners follows movements of a mouse cursor;
attaching a custom glass pane to the window where the mouse cursor is located; and
displaying a drag image approximate the mouse cursor using the custom glass pane, wherein the drag image represents the dragging object and moves with the mouse cursor.

16. The computer readable medium of claim 15, further comprising instructions for removing the custom glass pane from the window after the drag and drop operation.

17. The computer readable medium of claim 15, wherein the instructions for displaying include instructions for repainting the drag image using the custom glass pane.

18. The computer readable medium of claim 15, wherein the instructions for displaying comprises instructions for:
detaching the custom glass pane from a previous window; and
attaching the custom glass pane to a next window where the mouse cursor is currently located.

19. The computer readable medium of claim 15, further comprising instructions for saving a currently installed glass pane in a storage device before attaching the custom glass pane to the window.

20. The computer readable medium of claim 1, further comprising instructions for reattaching a previously saved glass pane to the window after removing the custom glass pane from the window after the drag and drop operation.
